(19) United States
(12) Patent Application Publication
(10) Pub. No.: US 2010/0263728 A1
(43) Pub. Date: Oct. 21, 2010

(54) REACTION VESSELS

(76) Inventors: Peter James Mawle, Bath (GB); Michael Waite, Kingscote (GB)

Correspondence Address: The BOC Group, Inc., 575 MOUNTAIN AVENUE, MURRAY HILL, NJ, 07974-2082, US

(21) Appl. No.: 12/376,331

(22) PCT Filed: Aug. 7, 2007
(86) PCT No.: PCT/GB2007/002970

§ 371 Date: Jun. 10, 2010

(30) Foreign Application Priority Data
Aug. 8, 2006 (GB) 0615759.8

(51) Int. Cl. F16L 41/00; B01D 15/04; B01D 35/30

(52) U.S. Cl. 137/1; 137/561 A; 210/289; 210/435

(57) ABSTRACT

The present invention relates to a liquid distribution or collection device for a vessel containing material to which the liquid is to be delivered, the device having a plurality of conduits extending from a liquid transport channel, in which at least one said conduit comprises a proximal end in communication with the liquid transport channel, a distal end remote from the liquid transport channel and, between said proximal and distal ends, a multiplicity of spaced apertures for passage of liquid, wherein a distal region of the conduit has a cross-sectional area d₂ that is smaller than the cross-section area d₁ in a proximal region of the conduit. The present invention also relates to an ion exchange or filtration vessel comprising said device and a method of distributing a fluid onto a substrate in a vessel using said device.

The invention relates to reaction vessels, primarily to ion exchange equipment, and in particular to liquid distribution and/or collector devices for use in such vessels, especially but not exclusively in relation to co-current ion exchange vessels.

Ion exchange beds are a well-established technology for the removal of contaminants from water streams. Water with contaminant is caused to flow through a vessel filled with an ion exchange material, typically in the form of granular material of chemical nature suitable for adsorbing the target contaminant. The purified water then flows out at the opposite end of the vessel. When the granular material has reached saturation it can be reactivated by passing through a regenerant. In the case of the ion exchange resins typically used in the purification of water, the regeneration is normally accomplished by passing a strong salt solution through the resin bed to release the contaminant into a smaller concentrated volume.

It is well known to those versed in the art that the operational goals for such systems are to both maximise the quantity of material adsorbed onto the bed from the liquid being treated, and remove this subsequently with the minimum volume of salt solution. Achieving the former requires an even distribution of water into the bed such that contaminant levels equally meet all volumes on the bed. Achieving the latter requires reducing or eliminating mixing of the salt solution with the water and similarly achieving even distribution into the bed, but importantly here with a flow approximately an order of magnitude lower than the flow of the liquid to be treated. Uneven distribution of the water to be treated or the regenerant can also lead to undesirable formation of channels through the bed, which results in inconsistent treatment of the water.

Numerous inventions and designs have been put forward to give an even distribution of water into the bed. GB Patent Specification No. 1331304 describes one embodiment that has been widely used. There remains a need, however, for further optimisation of the distribution, both with respect to the liquid to be treated and the regenerant.

The invention provides a liquid distribution or collection device for a vessel containing material to which the fluid is to be delivered, the device having a plurality of conduits extending from a liquid transport channel, in which at least one said conduit comprises a proximal end in communication with the liquid transport channel, a distal end remote from the liquid transport channel and, between said proximal and distal ends, a multiplicity of spaced apertures for passage of liquid, wherein a distal region of the conduit has a cross-sectional area that is smaller than the cross-sectional area in a proximal region of the conduit. Where, as is preferred, there is a multiplicity of conduits, it is preferred for most or all of the conduits to be so configured. In practice, it has been found advantageous for more than half of the conduits to be so configured. For example, in an embodiment described below there are ten laterally extending conduits of which six are configured in the manner defined above. It may in particular be expedient to include straight-sided conduits as shorter conduits where there are conduits of differing lengths. The device may advantageously be used in a vessel in which a chemical reaction or other processing step can be carried out. For example, the vessel may be a fluidized bed reactor, a filter vessel or an ion exchange vessel. The device offers particular advantages when used in an ion exchange vessel.

CFD modelling and confirmatory practical work has surprisingly shown that where the flow of water in the pipe of a distributor (also referred to as a “header”) is at a greater velocity perpendicular to the distribution holes, the volume passing out of the distribution holes in these areas is lower. This is seen in a basic header design including laterally extending conduits (also known as “laterals”) as described in patent 1331304. For example, in one header of the type described in GB 1331304, considerable variations in flow rate along the five pairs of lateral conduits present were determined as shown in Table 1.

TABLE 1

| Lateral Conduit | Minimum Flow Rate (l/s) | Maximum Flow Rate (l/s) |
|---|---|---|
| Lateral 1 | 0.02 | 0.024 |
| Lateral 2 | 0.014 | 0.024 |
| Lateral 3 | 0.012 | 0.025 |
| Lateral 4 | 0.015 | 0 028 |
| Lateral 5 | 0.022 | 0.029 |

The above variations in flow rate resulted in considerable variations in the amount of fluid delivered through different apertures along the respective conduits. The wider lateral diameter in the proximal part of the conduit, in accordance with the invention, reduces the relative velocity in that part of the conduit and hence increases the flow in the distribution holes. Thus, for a given volume of water, a greater proportion of the liquid flow is able to pass through those apertures in a proximal region of each conduit, that is, the regions of the conduits in the vicinity of the liquid transport channel, whilst a commensurately smaller proportion exits through those apertures in the distal region of the conduits, that is, regions of the conduits that are remote from the liquid transport channel. That is, a more even flow as between the distribution holes is made possible.

The cross-sectional area of said at least one conduit may decrease in stepwise fashion between said proximal end and said distal end. In one embodiment, said at least one conduit comprises a discontinuity, the cross-section proximally of the discontinuity being larger than the cross-section of the conduit distally of the discontinuity. It is also possible for said at least one conduit to have two or more discontinuities, the cross-section decreasing incrementally at each discontinuity. The relative sizes of each part of the conduit, and whether there are two, three, four or more incremental decreases in diameter, is a function of the size of the system and the flows required and can be calculated accordingly, as can the relevant sizes of holes along the respective conduit. In general, each length of the conduit upstream or downstream of a discontinuity, that is, each of a proximal region, a distal region, and if there are two or more discontinuities any intermediate region, will have a plurality of, and preferably three or more, apertures for passage of liquid.

Instead of one or more discontinuities, the at least one conduit may comprise one or more tapered portions in which the cross-section reduces in a direction towards the distal end. For example, the at least one conduit may taper from a first cross-section at the proximal end to a second cross-section at the distal end. Whilst a gradual reduction in cross-section can be advantageous in terms of achieving an even discharge of liquid from apertures along the length of the conduit, conduits of that configuration are less straightforward to manufacture than configurations having one or more discontinuity and may be less preferred for that reason.

The term “discontinuity” is used herein to refer to a stepped or a sharply tapering reduction in internal diameter of a conduit between straight cylindrical or more gently tapering regions. The term “tapered” is to be understood as including both configurations that define a frustoconical void space and configurations having surfaces that are contoured so as to define an internal void that, in longitudinal section, reduces non-linearly in width. Such contoured transitional portions can reduce turbulent effects on the fluid flow.

In a preferred embodiment there are a multiplicity of conduits extending from the liquid transport channel. It is preferred for the liquid transport channel to be in communication with a first group of conduits extending from the liquid transport channel in a first lateral direction and a second group of conduits extending from the liquid transport channel in a second, opposed, lateral direction.

Advantageously, the liquid transport channel extends in a longitudinal direction, the conduits extending transversely relative to the liquid transport channel. Preferably, there are a longitudinally extending liquid transport channel and a multiplicity of substantially parallel transversely extending conduits. Preferably, the liquid transport channel communicates with the conduits through a junction member which is in communication with the liquid transport channel through an opening in a bottom wall region of the liquid transport channel. The liquid transport channel and/or the conduits are each preferably circumferentially enclosed (except, of course, for the apertures). The liquid transport channel of the device according to the invention preferably has an open end which is in communication with a liquid supply (in the case of a distribution device) or liquid exhaust (in the case of a collection device), with the opposed end in each case preferably, but not necessarily, being closed. The conduits comprise a multiplicity of spaced apertures for the passage of liquid. Preferably, the apertures in the conduits provide the only outlets for the egress of liquid from the distribution device of the invention or the only inlets for the ingress of liquid into the liquid collection device of the invention. Preferably, the distal end of each conduit is closed. Preferably, there are no apertures in the walls of the liquid transport channel for the egress of liquid from the distribution device of the invention, or no apertures in the walls of the liquid transport channel for the ingress of liquid into the liquid collection device of the invention. Preferably, the apertures are distributed along the sides of the lateral conduits. Preferably, the apertures on each lateral conduit are aligned in one or more lines that extend along the length of the lateral conduit. Advantageously, the conduits each have a plurality of, preferably three or more, apertures for passage of liquid in a proximal portion of the conduit and a plurality of, preferably three or more, apertures for passage of liquid in a distal portion of the conduit that has a smaller diameter than the proximal portion. The apertures may be arranged in sets of apertures that are distributed around the circumference of the conduits and, preferably, the apertures are arranged in opposing pairs on opposite sides of the conduit. Preferably, the proximal portion, intermediate portion and/or the distal portion each have up to 15 apertures or sets of apertures, for example, up to 12 apertures or sets of apertures. The distal portion may in some cases have fewer apertures or sets of apertures, than the proximal or intermediate portion, for example, up to 10 apertures or sets of apertures when the proximal or intermediate portion has up to 15 apertures or sets of apertures. In an illustrative embodiment described in more detail below, by way of example only, in certain lateral conduits each of a proximal portion and a distal portion of the conduit have fewer apertures than an intermediate portion. The apertures may be of equal diameter. It is preferred, however, for the apertures to vary in size. The aperture size may vary as between different lateral conduits, along the length of one or more, preferably along all, of the lateral conduits, and/or between apertures on opposing sides of the conduit, thereby further facilitating achievement of even distribution of the liquid between apertures. The use of varying aperture size is described in more detail below, by way of example only, in a second illustrative embodiment.

The relative sizes of each portion of the lateral conduits, the number of steps (i.e. discontinuities), and the number and size of apertures are a function of the system and the flows required. Some further measures may in practice be desirable to minimise any remaining variations in distribution of liquid. The selection thereof will, with knowledge of the invention as disclosed herein, be a routine matter for those skilled in the art. It is also within the scope of the invention for the liquid to enter the distributor from one inlet or from more than one inlet, for example, from two inlets on opposite sides of the distributor. Arrangements with two or more inlets are in particular advantageous where the distributor is relatively large, for example, 1.2 m or more in diameter.

The device of the invention may in a preferred form be suitable for delivering a liquid to ion exchange material in the ion exchange vessel, especially for delivering a regenerant and/or liquid to be treated.

In another preferred form, the device is suitable for use as a collector for collection of regenerant or treated liquid from the ion exchange vessel.

The invention also provides a distributor for an ion exchange vessel, comprising a plurality of outlet conduits having a proximal end to which liquid is introduced in use, a distal end, and between said proximal and distal ends a multiplicity of apertures for egress of liquid, at least one of the outlet conduits having a cross-sectional area that is smaller in a distal region than in a proximal region. Advantageously, there is a feed conduit to which each of the outlet conduits is connected for receiving liquid from said feed conduit.

In an especially preferred arrangement, a distribution device comprises a first distributor according to the invention for delivery of regeneration fluid to ion exchange material in the ion exchange vessel, and a further distributor for delivery of treatment liquid to the ion exchange material for treatment therein, the further distributor also preferably being constructed in accordance with the invention. In that preferred form of distribution device the volumes of the outlet conduits of the regenerant distributor are smaller than the volumes of the outlet conduits of the treatment liquid distributor, whereby both distributors are adapted to provide an even distribution of regenerant or treatment liquid, respectively, and irrespective of the larger volumes of treatment liquid. The smaller distributor for the regenerant is preferably mounted directly underneath, and substantially in register with, the larger distributor for the treatment liquid.

The invention also provides an ion exchange vessel containing an ion exchange bed and comprising a distributor and a collector, the distributor and/or the collector being constructed in accordance with the invention. It will be appreciated that the flow out of the bottom of the ion exchange bed needs to match the distributor above such that flow rate is substantially equal across the full cross section of the bed. This can advantageously be achieved by providing a collector according to the invention which is of comparable volume to a distributor of the invention that is to be used for delivering the liquid to be treated.

The present invention is in particular applicable to co-current ion exchange vessels, that is, ion exchange vessels in which both the flow for treatment and the regenerant are fed into the bed in the same direction, from above. For the avoidance of doubt, application to other forms of ion exchange vessel in which one or more liquids is fed into the vessel from above or discharged from below is not excluded.

Certain illustrative embodiments are described in detail hereinafter with reference to the accompanying drawings, in which:

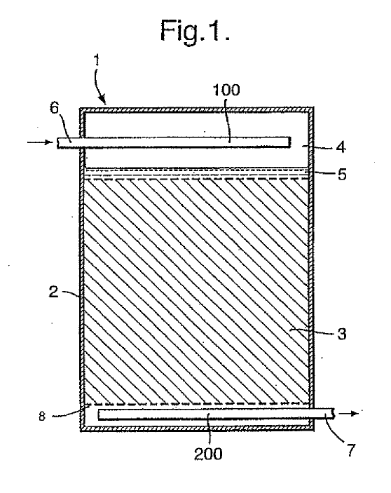

FIG. 1 is a schematic view of an ion exchange vessel;

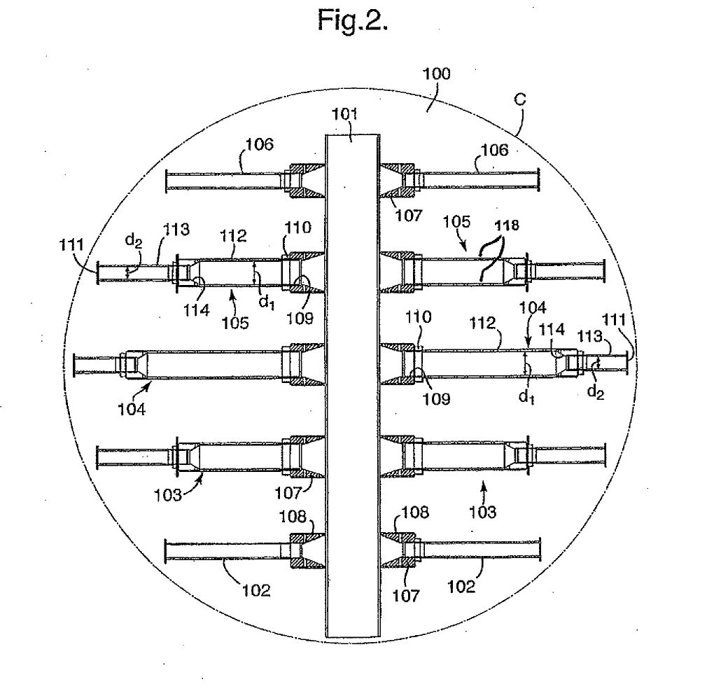

FIG. 2 is plan view of a first distributor in accordance with the invention;

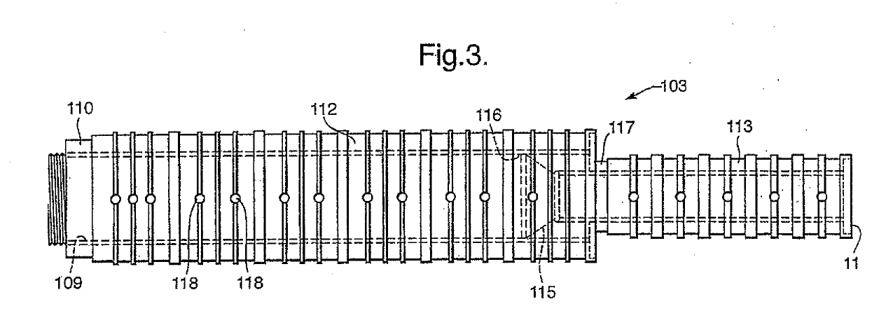

FIG. 3 is a side view of a lateral conduit of the distributor of FIG. 1;

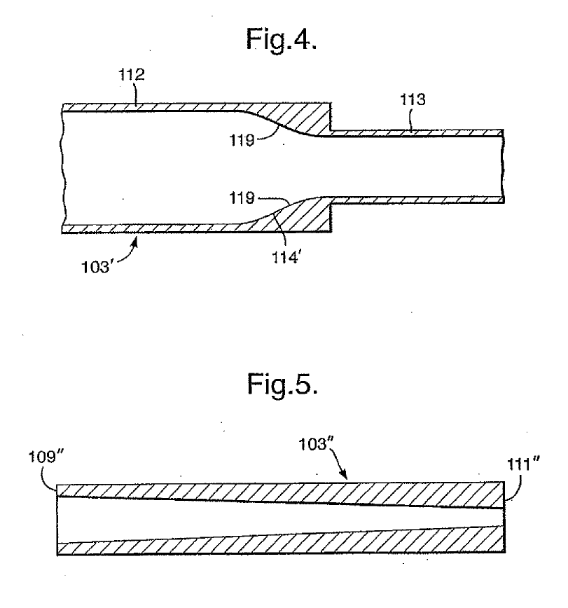

FIG. 4 is a longitudinal section through a discontinuity portion of a lateral conduit of a second distributor according to the invention.

FIG. 5 is a longitudinal section through a lateral conduit of a third distributor according to the invention;

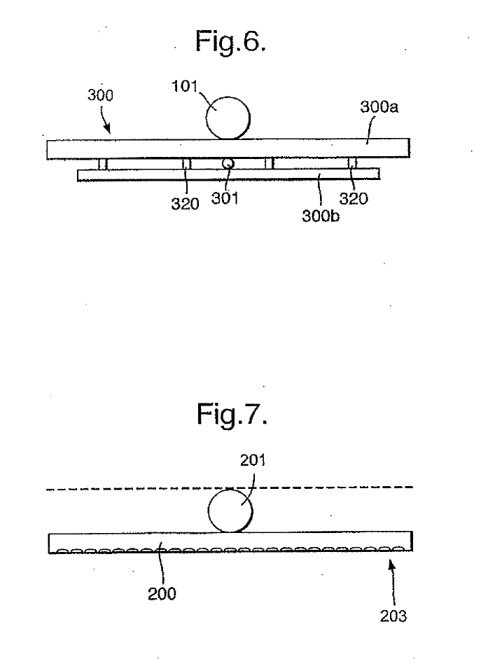

FIG. 6 is a side view of a fourth distributor according to the invention;

FIG. 7 is a side view of a collector in accordance with the invention, in situ in the bottom of an ion exchange vessel;

With reference to FIG. 1, an ion exchange vessel 1 has a housing 2 enclosing an ion exchange bed 3, above which there is a header region 4 which, in operation, may be partly filled by liquid 5, with a region of air above under pressure that may be varied to hold the liquid level at a predetermined level. An inlet 6 is provided near the top of the vessel, and an outlet 7 near the bottom of the vessel. The inlet 6 is in fluid communication with a distributor 100 which is located in the uppermost region of the vessel, and above the surface of the bed 3. The distributor extends substantially across the entire width of the bed.

Underneath the bed 3, separated therefrom by a mesh 8, and in fluid communication with the outlet 7, is a collector 200 for collecting effluent liquid from the bed.

In FIG. 2 there is shown a distributor according to a first embodiment of the invention. The distributor 100 has a longitudinally extending feed channel 101 and ten laterally extending conduits, of which five extend in a first direction and five in a second, opposed direction. The laterally extending conduits are of smaller diameter relative to the feed channel. The lengths of the conduits are selected such that the ends thereof remote from feed channel 101 define a notional circle as indicated by the line C in FIG. 2. Each transversely extending group of conduits is made up of a first, relatively short conduit 102, three longer conduits 103, 104 and 105, and a second shorter conduit 106. Each conduit is in fluid communication with the feed channel by means of a junction member 107. Each junction member 107 communicates with an aperture (not visible in FIG. 2) provided in an undersurface of the feed channel, and has two opposed arms 108 which communicate with opposed lateral pairs of conduits. The arms 108 have an internal cross-section that tapers towards the associated conduit. There are no apertures in the walls of the junction member 107 for egress/inlet of liquid. Whilst differing in length, each of conduits 103, 104, 105 is of generally the same configuration. A proximal end 109 of the conduit is located inside an arm 108 of the associated junction member 107, and retained in position by fitting 110. A distal end 111 of the conduit is located in a position remote from the feed channel 101. The end 111 may in use be secured to the ion exchange vessel or may be free. A first, proximal, region 112 of the conduit in the vicinity of the feed channel 101 has an internal diameter d₁ which is larger than the internal diameter d₂ of a second, distal region 113 of the conduit in the vicinity of the distal end 111. A discontinuity 114 is provided between the proximal region 112 and the distal region 113. Apertures for passage of liquid are indicated by reference numeral 118 and are arranged in opposing pairs on either side of the conduits 102, 103, 104, 105 and 106.

The conduit 103 is shown in greater detail in FIG. 3. As can be seen from FIG. 3, distal region 113 of the conduit includes a flared end piece 115, one end of which is located in distal region 113 and the other end of which flares outwardly to meet the internal wall 116 of proximal region 112. The flared end piece 115 is located wholly within the proximal region 112 and is retained in position by seal-forming member 117. Apertures are indicated by reference numeral 118.

It will be appreciated that, whilst there is shown a conduit configuration with two regions of different diameter d₁, d₂ separated by one discontinuity 114, it is also within the scope of the invention to have three or more regions of different diameters separated by two or more discontinuity, and that may in particular be desirable where the ion exchange vessel is of large diameter and the distributor laterals therefore relatively long.

In FIG. 4, there is shown a single arm or lateral conduit 103′ of a distributor which may be of similar general layout to the distributor of FIG. 1. In the conduit 103′ of FIG. 4, however, the discontinuity 114′ includes a contoured inner surface 119, which can help to minimise turbulent effects on the fluid flow.

In another alternative configuration of lateral conduit 103″ shown in FIG. 5 of a third distributor of the invention, there is no discontinuity. The entire conduit tapers from the proximal end 109″ to the distal end 111″. It will be appreciated that it is not essential for the angle of taper to be uniform along the length of the conduit 103″.

Referring now to FIG. 6, there is shown a fourth distributor device 300 according to the invention in which there are separate distributors 300a, 300b for liquid requiring treatment in the ion exchange vessel and for regenerant liquid. The two distributors are generally the same in shape and configuration but differ in size, with the feed channel 301 and each conduit being smaller in the distributor 300b for the regenerant than in the distributor 300a for the liquid to be treated. Each distributor has lateral conduits arranged generally in the layout described with reference to FIG. 2. The regenerant distributor 300b is mounted underneath, and in register with, the treatment liquid distributor 300a by means of struts 320. In use, liquid to be treated is delivered along the upper distributor via feed channel 101, whilst regenerant is delivered along the lower distributor via feed channel 301. Because that avoids the need for regenerant to be flushed from a single distributor before that same distributor can be used for delivery of treatment liquid, that dual-distributor arrangement is particularly effective in terms of reducing waste volumes generated by the system. Furthermore, the smaller volume of the lower distributor is better suited to the lower volumes of regenerant that are delivered to the bed.

In FIG. 7 there is shown a collector 200 constructed in accordance with the invention. The collector is of the same general construction as the distributor 100 of FIG. 2, and is located in the bottom of the vessel underneath the ion exchange bed, and separated therefrom by a mesh. The collector serves to collect effluent liquid evenly from all regions of the bed and to feed that effluent via the inlet conduits 203 and the outlet channel 201 to the vessel outlet (not shown).

An ion exchange vessel may advantageously contain a collector according to the invention in combination with a distributor according to the invention, although either provides advantages when used alone.

The following Examples illustrate the invention:

### EXAMPLE ONE

In an ion exchange vessel, there was used a distributor of configuration as shown in FIG. 2, except that the lateral conduits 102 and 106 were each provided with a discontinuity similar to the discontinuity 114 of lateral conduits 103, 104 and 105, whilst the conduits 103, 104 and 105 were each provided with a second discontinuity spaced from the single discontinuity 114 shown in each of those conduits in FIG. 2. The distributor was designed to deliver a liquid flow of 5 litres per second. The configuration of the distributor, including the approximate location and size of the pairs of distribution holes in a group of conduits extending from the liquid transport channel in a lateral direction, is further defined in Table 2, from which it will be seen that, in conduits 1 and 5, there is a proximal portion and a distal length (the second portion) separated by a single discontinuity whilst, in conduits 2, 3 and 4, there are two discontinuities dividing the respective conduit into a proximal portion, a distal portion (the third portion) and an intermediate portion therebetween (the second portion).

TABLE 2

| Con- | No. discon- | Hole size (mm) | Hole size (mm) | Hole size (mm) |
|---|---|---|---|---|
| duit | tinuities | proximal portion | 2nd portion | 3rd portion |
| 1 | 1 | 6.8 6.8 | 8.2 7.7 7.7 7.4 | n/a |
| | | | 7.4 7.4 7.1 7.1 | |
| 2 | 2 | 6.8 6.2 | 6.5 6.5 6.5 6.5 | 7.1 6.8 6.8 6.5 |
| | | | 6.5 6.5 6.5 | 6.5 |
| 3 | 2 | 6.2 6.2 | 6.8 6.8 6.8 6.8 | 6.6 6.6 6.5 |
| | | | 6.8 6.5 6.5 6.5 | |
| | | | 6.5 6.5 6.5 6.5 | |
| 4 | 2 | 6.2 6.2 | 6.5 6.5 6.5 6.5 | 6.8 6.5 6.5 |
| | | | 6.2 6.2 6.2 | 6.5 |
| 5 | 1 | 6.5 6.5 | 7.4 7.4 6.8 6.8 | n/a |
| | | | 6.8 6.5 6.2 6.2 | |

At the liquid delivery rate of 5 litres per second an even distribution of the liquid through the distribution holes and thus an even delivery to the ion exchange material was achieved. Furthermore, even when a brine solution was passed through the above distributor at a flow rate of only 1 litre per second, an even distribution through the distribution holes was still achieved. Thus, the distributor can provide good results in terms of distribution of the liquid being delivered both for delivery of water to be treated by the ion exchange material and of brine for regeneration of the ion exchange material when it becomes fully loaded, notwithstanding that the brine is in practice delivered at a considerably lower flow rate.

### EXAMPLE TWO

In a further exemplary embodiment of the invention, a distributor has a structure generally similar to that described in the Example One above, but with alteration of the diameter of certain apertures on opposing sides of certain lateral conduits. The sizes of apertures on the side of the lateral conduits facing toward the distributor inlet and direction of flow in the feed channel (“early” apertures), as compared to the opposing apertures facing away from the distributor inlet and direction of flow in feed channel (“far” apertures) are further defined in Table 3.

It will be seen that, in the proximal and second portions of all lateral conduits, certain “far” apertures are larger than the opposing “early” apertures. In laterals 2 and 4, certain “early” apertures are larger than the opposing “far” apertures. These variations in aperture size further facilitate the achievement of even distribution of the liquid from the apertures. Other minor differences in the “early” and “far” apertures allow for variations of flow in the laterals to be further evened out.

TABLE 3

| | | | Hole | | Hole |
|---|---|---|---|---|---|
| | | No. | size (mm) | Hole | size (mm) |
| | | dis- | proximal | size (mm) | 3rd |
| Conduit | Aperture | continuities | portion | 2nd portion | portion |
| 1 | early | 1 | 6.8 6.8 | 8.2 7.7 7.7 | n/a |
| | | | | 7.4 7.4 7.4 | |
| | | | | 7.1 7.1 | |
| 1 | far | 1 | 6.8 8.2 | 8.2 8.2 7.7 | n/a |
| | | | | 7.4 7.4 7.4 | |
| | | | | 7.1 7.1 | |
| 2 | early | 2 | 6.8 6.2 | 6.5 6.5 6.5 | 7.1 6.8 |
| | | | | 6.5 6.5 6.5 | 6.8 6.5 |
| | | | | 9.5 | 6.5 |
| 2 | far | 2 | 6.5 6.8 | 7.4 6.8 6.8 | 6.5 6.5 |
| | | | | 6.5 6.5 6.5 | 6.2 6.2 |
| | | | | 9.5 | 6.2 |
| 3 | early | 2 | 6.2 6.2 | 6.8 6.8 6.8 | 6.5 6.5 |
| | | | | 6.8 6.8 6.5 | 6.5 |
| | | | | 6.5 6.5 6.5 | |
| | | | | 6.5 9.5 | |
| 3 | far | 2 | 6.2 6.5 | 7.1 7.1 7.1 | 6.5 6.5 |
| | | | | 6.5 6.5 6.5 | 6.5 |
| | | | | 6.5 6.5 6.5 | |
| | | | | 6.5 9.5 | |
| 4 | early | 2 | 6.2 6.2 | 6.5 6.5 6.5 | 6.8 6.5 |
| | | | | 6.5 6.2 6.2 | 6.5 6.5 |
| | | | | 9.5 | 6.5 |
| 4 | far | 2 | 6.2 6.2 | 6.8 6.8 6.8 | 6.8 6.8 |
| | | | | 6.8 6.5 6.5 | 6.5 6.2 |
| | | | | 9.5 | 6.2 |
| 5 | early | 1 | 6.5 6.5 | 7.4 7.4 6.8 | n/a |
| | | | | 6.8 6.8 6.5 | |
| | | | | 6.2 6.2 | |
| 5 | far | 1 | 6.5 6.5 | 7.4 7.4 7.1 | n/a |
| | | | | 7.1 6.8 6.5 | |
| | | | | 6.2 6.2 | |

1. A liquid distribution or collection device for a vessel containing material to which the liquid is to be delivered, the device having a plurality of conduits extending from a liquid transport channel, in which at least one conduit comprises a proximal end in communication with the liquid transport channel, a distal end remote from the liquid transport channel and, between said proximal and distal ends, a multiplicity of spaced apertures for passage of liquid, wherein a distal region of the at least one conduit has a cross-sectional area that is smaller than a cross-sectional area in a proximal region of the conduit.

2. A device according to claim 1, wherein the cross-sectional area of said at least one conduit decreases in stepwise fashion between said proximal end and said distal end.

3. A device according to claim 2, wherein said at least one conduit comprises a discontinuity, the cross-section proximally of the discontinuity being larger than the cross-section of the conduit distally of the discontinuity.

4. A device according to claim 3, wherein said at least one conduit includes a plurality of discontinuities, the cross-section decreasing incrementally at each discontinuity.

5. A device according to claim 1, in which wherein said at least one conduit comprises at least one tapered portion in which the cross-section reduces in a direction towards the distal end.

6. A device according to claim 5, wherein said at least one conduit tapers from a first cross-section at the proximal end to a second cross-section at the distal end.

7. (canceled)

8. A device according to claim 1, in wherein the liquid transport channel is in communication with a first group of the plurality of conduits extending from the liquid transport channel in a first lateral direction and a second group of the plurality of conduits extending from the liquid transport channel in a second, opposed, lateral direction.

9. A device according to claim 1, wherein the liquid transport channel extends in a longitudinal direction, and the plurality of conduits extends transversely relative to the liquid transport channel.

10. A device according to claim 9, wherein the plurality of conduits extend substantially parallel with each other.

11. A device according to claim 1, wherein the liquid transport channel communicates with the plurality of conduits through a junction member which is in communication with the liquid transport channel through an opening in a bottom wall region of the liquid transport channel.

12. A device according to claim 1, wherein each one of the plurality of conduits each have a plurality of apertures for passage of liquid in a proximal portion of the conduit and a plurality of apertures for passage of liquid in a distal portion of the conduit that has a smaller diameter than the proximal portion.

13. A device according to claim 12, wherein a diameter of the plurality of apertures varies along a length of one or more of said conduits.

14. (canceled)

15. A device according to claim 1 for use as a distributor in an ion exchange vessel for delivering a liquid to ion exchange material in the ion exchange vessel.

16. A device according to claim 15, for delivering regenerant to the ion exchange vessel.

17. A device according to claim 15, for delivering liquid to be treated in the ion exchange vessel.

18. A device according to claim 1, for collection of regenerant or treated liquid from an ion exchange vessel.

19. A distributor for an ion exchange vessel, comprising a plurality of outlet conduits, each of which having a proximal end to which liquid is introduced in use, a distal end, and between said proximal and distal ends a multiplicity of apertures for egress of liquid, at least one of the outlet conduits having a cross-sectional area that is smaller in a distal region than in a proximal region.

20. A device according to claim 19, comprising a feed conduit to which each of the outlet conduits is connected for receiving liquid from said feed conduit.

21. A distribution device for use in an ion exchange vessel, comprising a distributor according to claim 19 for delivery of regeneration fluid to ion exchange material in the ion exchange vessel, and another distributor for delivery of treatment liquid to the ion exchange material for treatment therein.

22. A distribution device according to claim 21, wherein the another distributor is for delivering liquid to be treated in the ion exchange vessel.

23. A distribution device according to claim 22, wherein volumes of the outlet conduits of the regenerant distributor are smaller than volumes of the outlet conduits of the treatment liquid distributor.

24. An ion exchange vessel comprising a distributor and/or a collector according to claim 1.

25. A reactor vessel comprising a distributor and/or a collector according to claim 1.

26. A filtration vessel comprising a distributor and/or a collector according to claim 1.

27. A method of distributing a fluid onto a substrate in a vessel, comprising causing the fluid to pass along a conduit having a multiplicity of apertures, and varying a cross-sectional area of the conduit, wherein flow rate of the fluid along the conduit is maintained substantially uniform.
